(19) United States
(12) Patent Application Publication
(10) Pub. No.: US 2012/0187694 A1
(43) Pub. Date: Jul. 26, 2012

(54) Converting Kinetic Energy Using a Hydrofoil

(75) Inventor: Terje Engervik, Kristiansand (NO)

(73) Assignee: ENGERVIK TECHNOLOGY AS, Kristiansand (NO)

(21) Appl. No.: 13/395,272

(22) PCT Filed: Sep. 23, 2009
(86) PCT No.: PCT/NO09/00332

§ 371 Date: Apr. 4, 2012

(51) Int. Cl. F03B 13/00; F04B 35/00

(52) U.S. Cl. 290/54; 417/53; 417/334

(57) ABSTRACT

A method compressing a gas, advantageously air, is disclosed. The gas is compressed by disposing one or more hydrofoils in a liquid flow for the purpose of generating a downpull and thereafter a lift by altering the angle of attack on the hydrofoil relative to the flow of liquid, advantageously water. The down force causes the load, advantageously air, to be submerged, and hence compressed proportional to the depth of liquid to which the air is subjected. The hydrofoil is attached to a mechanical device, which in turn is anchored or moored in the depth of the liquid and at or under the surface. The angle of attack of the hydrofoil is altered by mechanical devices connected to tension bars or strings or by flaps. The volume of air loaded in the hydrofoil is adapted such that the down force is greater than the buoyancy of the air. An accelerating effect is achieved by that the volume of air decreases inversely proportional to the increasing depth to which it is subject. At arrival on the intended depth, the volume of the compressed gas is pressure locked. The hydrofoil is disposed to a unload station on the surface, or under water by altering the angle of attack of the hydrofoil, after which the compressed air is unloaded and conveyed further for utilization for energy purposes.

### BACKGROUND

1. Field of the Invention

The present invention concerns a method and apparatus for converting kinetic energy in a flow of liquid using a hydrofoil. In a preferred embodiment, a cyclic vertical movement of the hydrofoil is used to repeatedly compress air and release the pressurized air at or near the surface.

2. Prior Art

One of today's major challenges is to provide renewable energy inexpensive enough to compete with fossil fuels and other non-renewable energy sources.

The invention aims to convert the kinetic energy in a natural flow of liquid, in particular water, to a usable form. These natural flows of liquid may include rivers, streams, tidal currents, ocean currents or any other flow of liquid, in particular water.

As a first example, the Earth's ocean currents comprise enormous amounts of kinetic energy. There are two ocean currents in the world having a velocity over 3 knots, the Gulf Stream and the Kuroshio. The Gulf Stream conveys water at a rate between 30,000,000 m³/sec (30 Sv) and 80,000,000 m³/sec (80 Sv). The velocity of the Gulf Stream varies with topographical conditions. The Gulf Stream is up to 200 km wide, whereas the core, wherein velocities above 2 m/s (5 knots) occur, is 90 km wide.

The Gulf Stream has small seasonal fluctuations, which means that the energy is constant throughout the year. The Gulf Stream is driven by the Coriolis-effect caused by the Earth's rotation.

The Gulf Stream reaches its highest velocity off Florida, with a peak velocity of 7.75 mph (6.73 knots) at the centre. The current also has a depth from 300 meters to about 1200 meters.

The amount of energy in water in motion is of course higher than in air, as water has a density of 860 times that of air.

Some prior techniques are based on inserting some form of rotating wheels, e.g. propellers or turbine vanes, driving a generator into a tidal stream, a river etc to convert the kinetic energy of the of the rotor to electric current and voltage. There are several mechanical solutions for retaining such rotating wheels, propellers or rotor blades in a sea current. Common means include a frame mounted on the seabed or a mooring via an anchor line to the sea bed, often with a ballast in order to stabilize the generator in the water/flow.

There is a limitation in the amount of energy that can be converted by such methods. The limitation is due to the area of the propeller blades or rotor blades, as the area is directly proportional to the energy generated. The area of a propeller blade is provided by the expression:

A=z∫c(r)dr

Z=number of blades
C(r)=chord

The power (KE) obtainable from the flow of liquid increases with velocity and area, thus:

$$KE = \frac{1}{2} a * ρ * {U}^{3}$$

a=Area
p=density
U=velocity

Hence, to collect more kinetic energy from the flow of liquid, the area of the propeller or turbine must increase. This also increases the forces on the equipment and mooring. To avoid too large forces on the equipment, the energy to be converted is limited. As is apparent from the above, these methods of prior art still faces major challenges in generating sufficient amounts of energy. Use of wheels, rotor blades, or propellers generates too little energy with regard to the market requirements, and with regard to the cost/benefit ratio.

These disadvantages may be overcome by using a wing or foil rather than a propeller or turbine.

NO 326942 discloses an apparatus for energy from a flow of water, preferably for production of electrical current. The apparatus comprises at least one wing or hydrofoil. The hydrofoil is movable mounted in a supporting structure for reciprocating motion between a first and second turning point. Turning devices assist in changing the angle of attack of the hydrofoil with respect to the direction of fluid flow.

U.S. Pat. No. 6,273,680 shows an apparatus for converting the kinetic energy in a fluid flow to usable energy by means of a plurality of thin foils (aero- or hydrofoils) disposed in the flow. Barriers may be positioned around the apparatus for increasing efficiency by increasing the fluid velocity. A system of flywheels is used to increase inertia of the foils. The cascade of foils may be mechanically oscillated to transfer energy to a fluid.

WO 94/21914A2 shows a flow body in the shape of an adjustable wing. The profile and volume of the wing can be adjusted.

Further, the prior art methods generally disclose methods for generating electricity. Thus, the challenge of making the energy conveyable (energy carrier) with a least possible loss of efficiency remains, not in the least considering the limited amount of energy obtained from the prior art methods. By converting to energy carriers such as, for example, batteries or hydrogen by known methods, energy loss is suffered at each conversion.

An objective of the present invention is thus to provide renewable alternatives providing a sufficient amount of energy to be able to replace the present consumption of fossil fuels.

Another object is to convey generated renewable energy to the consumer without losing substantial amounts of energy by one or more transformations and reloads during transport.

### SUMMARY OF THE INVENTION

This is achieved according to claim 1 by providing a method for converting kinetic energy in a flow of liquid, wherein a foil is disposed in the flow of liquid such that the foil can be moved cyclically in directions perpendicular to the flow of liquid between an uppermost level and a lowermost level depending on the lift of the foil, which method comprises the steps of:

confining a compressible fluid in a pressure tank attached to the foil at a first pressure when the foil is at the uppermost level,

controlling the lift of the foil such that the foil is subjected to a force in a downward direction,

allowing the compressible fluid to compress as long as the foil is moving downwards,

confining the compressed fluid in the pressure tank at a second pressure when the foil is at the lowermost level,

controlling the lift of the foil such that the foil is subjected to a force in an upward direction,

preventing the compressible fluid from expanding while the foil is moving in an upward direction, and

removing the potential energy of the compressed fluid from the pressure tank when the foil is at the uppermost level.

The invention also comprises an apparatus for carrying out the method.

In a preferred embodiment, air is compressed and later expanded. The compression process occurs when air is confined in a hydrofoil, which in turn is submerged in a liquid, preferably moving water, wherein the kinetic energy in the flow of water is employed for submersion and rising of the hydrofoil. The air is compressed naturally during submersion, and is trapped in a compressed volume before rising.

As is apparent from the above, the energy is represented by the motion of mass present in ocean currents, that is in clean and renewable form. This energy is stable throughout the year, and is present in amounts sufficiently large to cover the global energy needs.

The invention thus implies that the environmental balance sheet is substantially improved in comparison to prior art methods by the substantially larger volume of energy that can be generated by the invention.

### BRIEF DESCRIPTION OF THE DRAWINGS

The invention will be explained in greater detail with reference to the accompanying drawings, wherein:

FIG. 1 is a schematic view of a wing or hydrofoil having at least one pressure tank during a cycle of compression and surfacing with pressurized air.

FIG. 2 is a schematic view illustrating how angle of attack is used to provide positive or negative lift.

FIG. 3 illustrates the use of tension bars

FIG. 4 illustrates the additional use of a wire and pulleys to create a rotation, which in turn can be converted to electrical energy.

FIG. 5 shows a generic wing

FIG. 6 a-c are schematic views of a pressure tank at different stages of the cyclic motion of the wing.

### DETAILED DESCRIPTION OF A PREFERRED EMBODIMENT

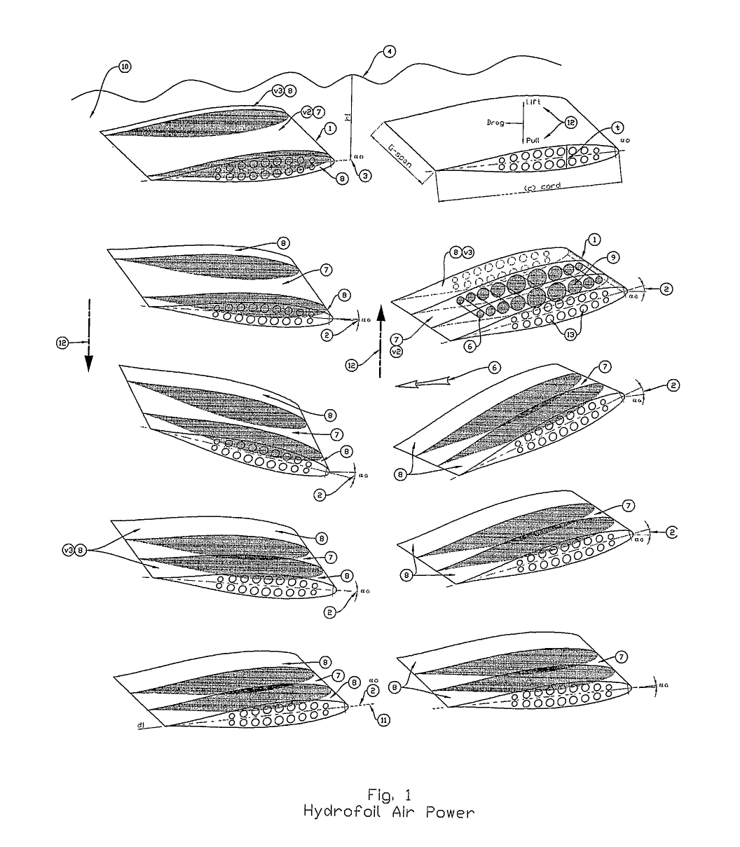

FIG. 1 illustrates the method, and shows a hydrofoil (1) disposed in a liquid (10) having a flow (6). Gas, advantageously an air volume (7) is disposed advantageously within the hydrofoil (1). The volume of the air is adjusted to the down force (12) of the hydrofoil, such that the down force becomes greater than the buoyancy caused by the gas volume. The angles of attack (2) are adjusted to provide a down force and a downward motion. Hence, the hydrofoil (1) becomes submerged, and the air volume is compressed relative to the instantaneous depth of the hydrofoil (1), to volume V₂ (7). This happens when the end walls (9) are pushed inwards by the surrounding liquid pressure. The volume V₂ is replaced by surrounding water entering through openings (13). The volume (8) V₃ expands proportional to depth. The deeper the hydrofoil is brought, the higher the pressure it is exposed to, which causes V₂ to decrease correspondingly.

An accelerating effect is achieved by that the volume of air decreases inversely proportional to the increasing depth to which it is subject.

When the foil has arrived at the intended depth (d1) (11), the angle of attack is altered such that the hydrofoil gets a lift and rises. The walls (9) of the foil volume V₂ (7) are locked by a mechanical device, which means that the compressed pressure in the air is kept, as the volume does not expand because of the locking. Hence, during rising the air becomes an energy carrier.

The hydrofoil eventually rises towards the surface (4). Once the hydrofoil has arrived at the surface (4) or a predetermined depth (h₁)(3), the pressure tank V₂ (7) is advantageously connected to conduits and/or pipes that convey the pressurized air to containers for transport or to a pipeline for later use of the energy.

By locating a hydrofoil as described above and illustrated in FIG. 1 within a flow of liquid, either a lift or a down force can be created by adjusting the angle of attack by the foil itself, by flaps, or support, or by design of the foil shape. The design is illustrated in the accompanying drawings and examples as a symmetrical hydrofoil shape, although it is not a prerequisite that the foil is symmetrical. An asymmetrical foil can also be used. The shape of the hydrofoil would depend on the concrete application.

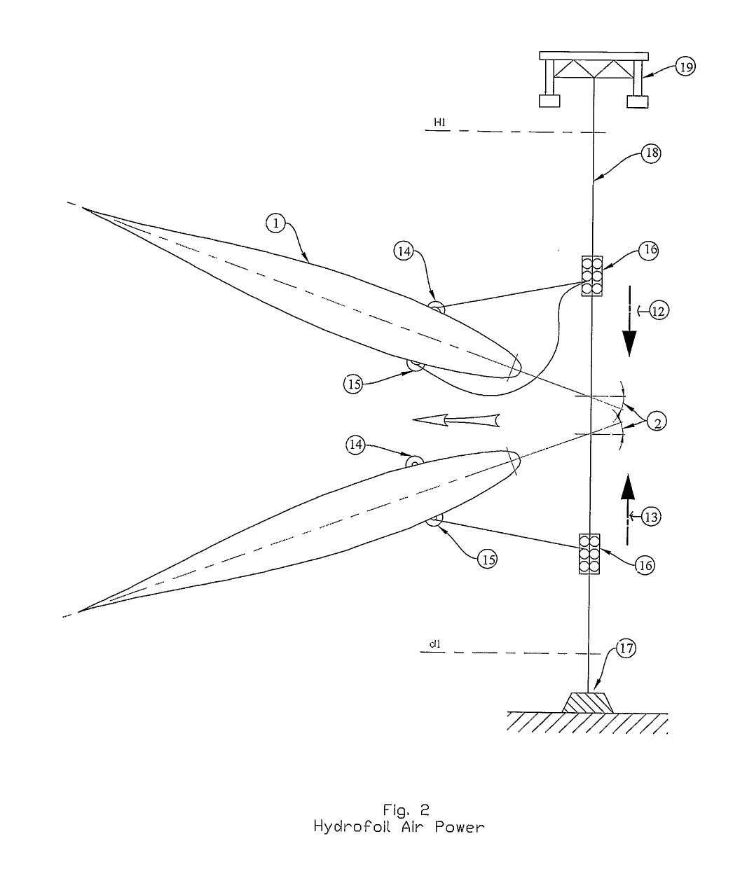

FIGS. 2-4 illustrates the preferred embodiment.

Several different alternative mechanical devices may be applied to provide the path of the hydrofoil in the cycle of submersion and surfacing, such as a framework, tension bars, anchors/mooring or the like. Connection to the device is designed such that it can adjust the hydrofoil's angle of attack relative to the flow of liquid.

FIG. 2 shows a tension bar (18) which is connected to a surface platform (19) and anchored in the sea bed (17). At a retaining point (14) on the upper face of the hydrofoil (1) (down force) and alternately on the lower face (15) (lift), the angle of attack (2) is altered such that the cycle of submersion and rising can be performed. Attachment to the tension bar (18) is implemented by a glider (16). The cycle starts at retainer in (14). Once the hydrofoil has arrived to a predetermined depth (d1), the retainer (14) is released, advantageously by means of a pressure activated quick release coupling. The retainer in (15) takes over, and the angle of attack is altered such that a lift, and hence a rising cycle, is started. Once the hydrofoil arrives at the top of the cycle (surface or near surface), (h1) and the pressurized air is unloaded, the wire is once more connected to retainer (14) and a new downpull cycle starts.

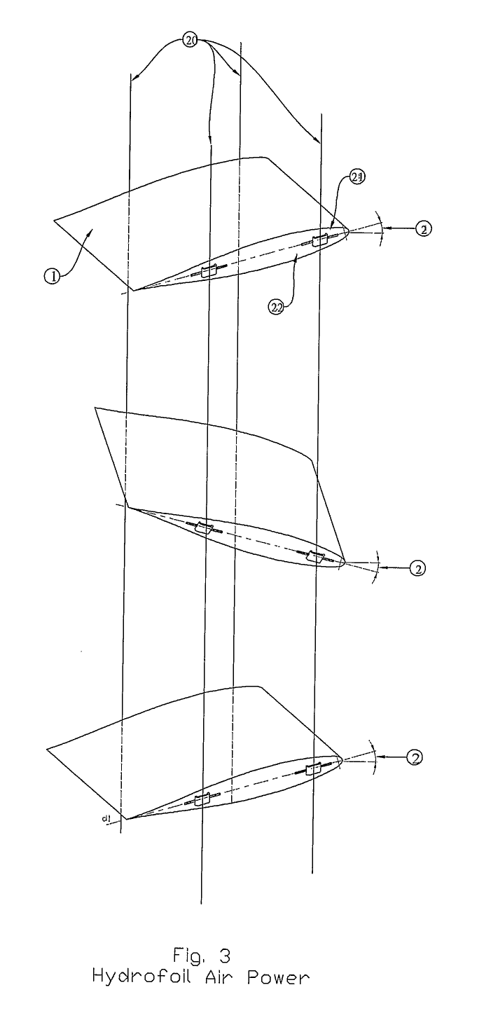

FIG. 3 shows an example of several tension bars (20) which are connected to a surface platform and anchored in the sea bed. The hydrofoil is connected to the tension bar (20) by retaining means (21) adjustable on the tension bar and a groove in the foil (22). The retaining devices are designed such that the angle of attack (2) of the hydrofoil in the flow can be adjusted.

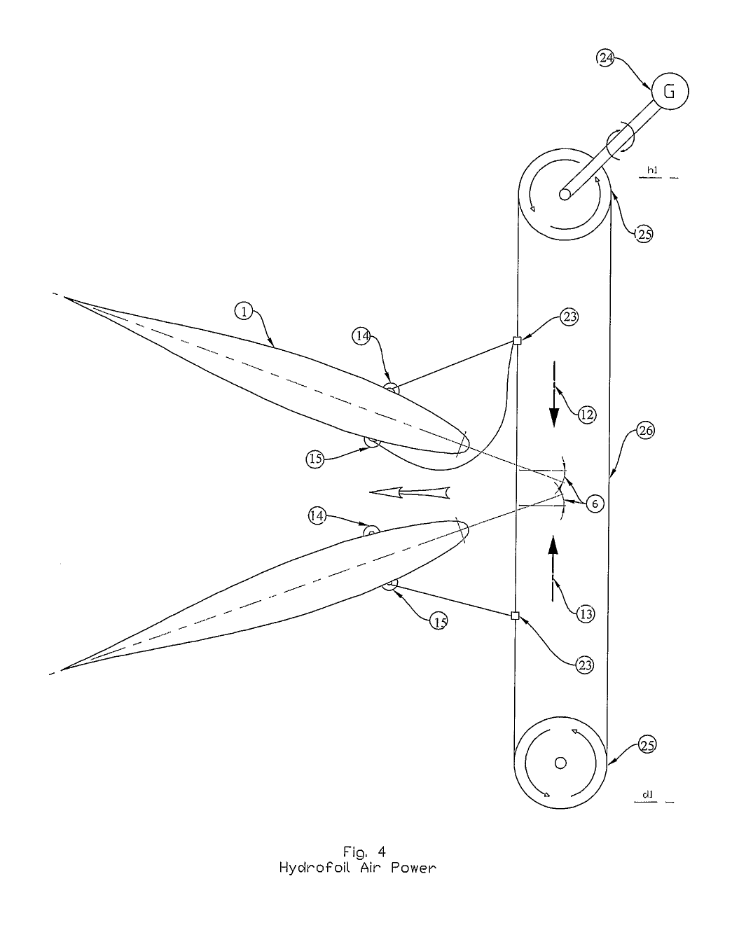

In FIG. 4 is shown an example on a tensioned string (26) anchored in a liquid similar to the previous description. At a retaining point (14) on one side of the hydrofoil (1), and alternately on the other side (15), the angle of attack (2) is altered such that the cycle of submersion (12) and rising (13) can be performed. Attachment to the string (26) is fixed by the retainer (23). By the connection (23) the path (26) will rotate around the pulleys (25) and provide kinetic energy. This kinetic energy is collected by devices (24), which may be electric generators, compressors or other known energy utilization methods. By this embodiment energy may be collected as previously described.

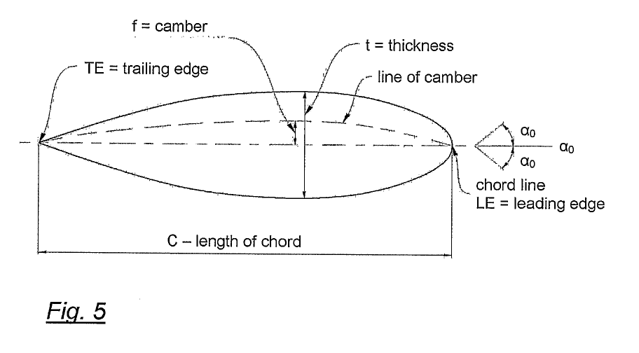

FIG. 5 illustrates the elements of a generic wing. As an alternative to adjusting the angle of attack, the profile of the wing might be altered to achieve the required lift and down force.

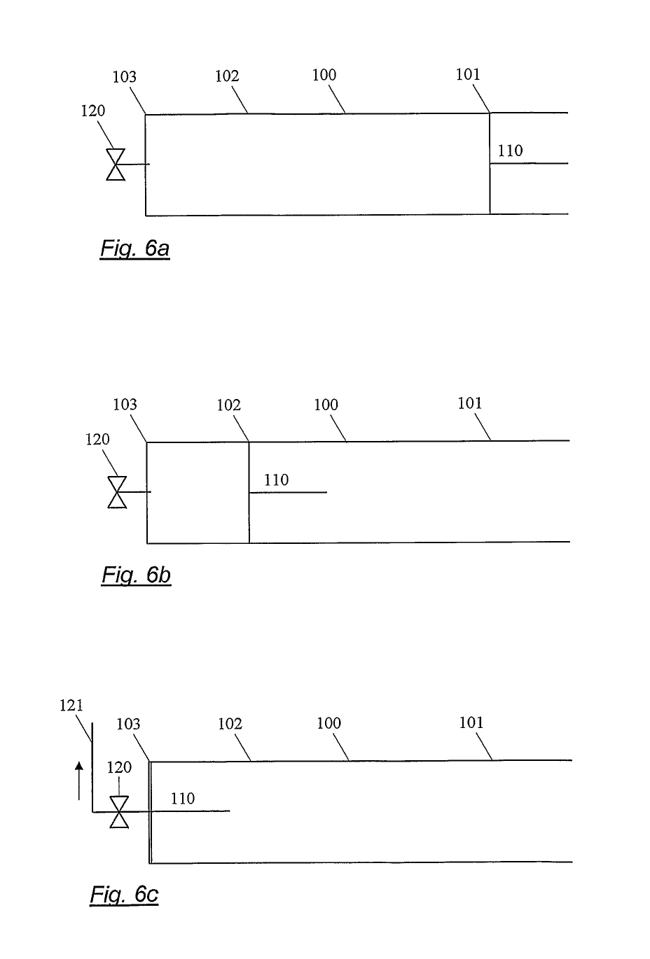

FIG. 6a is a schematic view of a pressure tank comprising a housing (100) and a piston (110). The piston (110) is slidably mounted in the housing (100), and sealed against the inner surface of the housing (100). FIG. 6a illustrates a situation where the volume defines by the inner surface, the piston (110) and an end wall (103) of the housing is filled with a compressible fluid, e.g. air, and the piston is as far from the end wall (103) as possible. This corresponds to the situation where the hydrofoil is at its uppermost position (h1). The housing has a valve (120) and an inlet through which the compressible fluid can be supplied. In FIG. 6a it is assumed that the tubing for supply of compressible fluid is removed, and that the valve (120) is closed.

The piston (110) is exposed to the ambient pressure. As the pressure increases, the piston (110) moves towards the end wall (103), keeping equilibrium between the ambient pressure and the pressure of the compressible fluid.

FIG. 6b illustrates the situation corresponding to the hydrofoil being at its lowermost or deepest position (d1). The piston (110) is at a position (102) wherein locking means prevents the piston (102) from retracting (and the pressurized fluid from expanding) when the hydrofoil starts rising towards the surface.

In FIG. 6c, it is assumed that the hydrofoil once more is at its uppermost position (h1), and that tubing (121) is connected to the valve (120). The valve (120) is opened, and the piston (110) can be moved further towards the end wall (103) for evacuation of the pressurized fluid through the open valve (120) and tubing (121).

The tubing (121) can later be used to provide new compressible medium, e.g. fresh air, before the tubing (121) is removed and valve (120) is closed as shown in FIG. 6a, thus starting a new cycle.

### Utilization of Additional Energy

In addition to that the down force is utilized to compress the air as described above, the same motion may be utilized to extract additional power by adjusting the supportive device for the motion path of the hydrofoil.

If the hydrofoil is attached to a string, advantageously a wire, this can be wound around pulleys attached to a mooring apparatus in the depth of the liquid and in a floating or submerged surface platform respectively. Rotation of the pulleys creates a work. The work in the pulley at the surface of the liquid is transferred via a transmission unit, e.g. a shaft, to an energy utilizing device, e.g. a compressor or a generator.

During submersion of the hydrofoil the air volume will decrease, as noted above, proportional to the depth. By the steadily decreasing volume, the buoyancy will decrease correspondingly. The down force will be constant, leading to an increased velocity. This implies that more load can be applied to the hydrofoil proportional to the decreasing buoyancy, which in turn implies that the string can be further loaded by the pulley which is connected to an energy utilizing device. The load that the energy utilizing device can apply to the pulley corresponds to the additional work created by the wheel when the velocity is kept constant.

### EXAMPLES

The lift or down force gives the following force in Newton (N):

$$Z = \frac{{r}_{ho}}{2} {U}^{2} {C}_{t} S$$

Cₜ=lift coefficient
S=Area of hydrofoil

### Rₕₒ=Liquid

### U=Velocity

The parameters involved in calculating the lift coefficient are shown in FIG. 5.

c=length of chord
f=camber
t=thickness
k=line of camber
LE=leading edge

TE=trailing edge

1) The lift coefficient is given by the expression:

$${C}_{t} = \frac{Z}{\frac{{r}_{ho}}{2} {U}^{2} S}$$

2) And the lift coefficient is given by the expression

$$Ct = \frac{{K}_{ϕ} ( \frac{\partial {C}_{t}}{\partial α} ) ( α + {α}_{0} - Δ {α}_{0} )}{1 + ( \frac{\partial {C}_{t}}{\partial α} ) ( \frac{{K}_{ϕ}}{π L} ) ( 1 + τ ) E}$$

3) The lift coefficient relative to the angle of attack is given by the expression:

$$( \frac{\partial {C}_{t}}{\partial α} ) = 5.5 {α}_{0} = 1.74 f$$

4) The effect on the surface is given by the expression:

k_{φ}=1−(0.5+c)exp[−2(h)^{0.6}]

5) Zero angle correction is given by the expression:

$$Δ {α}_{0} = \frac{c}{2} ( \frac{1}{{k}_{ϕ}} - 1 )$$

6) Drag caused by resistance and lift induced drag is expressed by:

τ=0.09\sqrt{L}−0.04

7) Lambda and Dzetta is expressed by:

$$δ \frac{h}{L} = 0.85 + \frac{0.16}{\sqrt{\frac{h}{L}}}$$

8) Under the conditions:

$$0.02 < \frac{h}{l} < 1.0$$

The hydrofoil is immersed in a flow of liquid for the purpose of being put to continuous movement, while simultaneously carrying a load, preferably air. The force, either as a down force or a lift, can be shown by the following example:

S=1000 m²

### C_{f}=1.33

U=1.7 m/s (symmetrical foil)

We obtain a lift/down force

$$Z = \frac{1000}{2} {1.7}^{2} * 1.4 * 1000 = 2 \text{,} 023 \text{,} 000 N$$

Here it appears that a large force may be achieved, even if the flow of liquid is not larger than 1.7 m/s or 3.3 knots. An ocean current like the Gulf Stream will give 6.73 knots, but in the following examples we use 1.7 m/s for conservative reasons. A hydrofoil with the above exemplary profile and area may have the following volume:

V=A*L=22.5 m²*100 m=2250 m³

### A=Area

### L=Length

In order to convert this force to energy, a load is provided, preferably air, and preferably the air volume within the foil or cylinders or similar devices carried by or within the hydrofoil. The buoyancy corresponds to the mass of displaced fluid according to Archimedes' principle:

$$\frac{{ρ}_{O}}{{ρ}_{f}} = \frac{weight}{weight - weight immersed}$$

ρₒ=density of object
ρ_{f}=density of fluid

Net buoyancy is given by:

Fₙₑₜ=mg−ρVg

m=mass
g=acceleration of gravity
ρ=density
V=volume

In order to obtain the submersion disclosed herein, we deduce:

Z>Fₙₑₜ

which gives:

$$\frac{{r}_{ho}}{2} {U}^{2} {C}_{t} S > m g - ρ Vg$$

In order to pull down 1 m³ air with a velocity of one meter per second, for example, the force must exceed 10, 000 Newton. In the aforementioned theoretical example, it is possible to pull down 202 m³ air. As the air is compressed as a consequence of the increasingly deeper levels in which it is located, the volume and hence the load decreases, whereby an increased velocity is achieved. In other words, we obtain compressed air, which in turn is potential energy. Once the foil with its air cargo has reached a predetermined depth, the angle of attack on the foil is altered, and return towards the surface. The air will then have a pressure expressed by Boyle's law:

p₁V₁=p₂V₂

As mentioned, the air reduces its volume during submersion, and will keep the pressure when rising by a mechanical lock-in or a bag being pushed into a mechanical device. This may e.g. be accomplished in that the cylinders or room containing the air have end walls which may be moved inwards by the ambient pressure. At the same time, these end walls are locked in position once the volume reaches a certain size and the hydrofoil has reached a predetermined depth. The locking may be performed by spring loaded bushings and gaskets or the like. A piston-like device may be used, wherein one or both end walls of the hydrofoil approaches each other as the air volume decreases. Such a device is within present prior art for common design of mechanical devices, and is hence not described any further. The reduced air volume is replaced by, for example, water displacing the air during submersion. The water enters the hydrofoil through openings. See the detailed description of FIG. 1 below.

When the foil arrives at the surface or a predetermined depth, it is advantageously docked in a frame, where couplings for pipes/conduits ensure that the pressurized air is transferred to storage tanks for further transport. The frame structure can alternatively be localized under water in order to avoid obstacles to sailing traffic. Present technology for offshore oil activities can perform all these operations in shallow waters, unloading to a ship by a connection in the hull under water.

Performing the unloading of the pressurized air will depend on the actual topographical conditions and the distance from the shore.

By using air as load, one goes directly from kinetic energy to pressurized air, a potential energy which in turn is an excellent energy carrier. The most frequently used present energy carriers are: petroleum, batteries, hydrogen and wood. Pressurized air is also a good energy carrier, but little used. Pressurized air has become more actualized as technology on carbon flasks/pressurized containers that can replace metal, which reduces the weight considerably. Most present machinery can be driven by pressurized air. There are, for example, cars working adequately on pressurized air as fuel (cf. www.theaircar.com).

The energy acquired in this manner depends on the variables: Area, speed and mass, which is transformed to pressurized air. The amount of energy in the pressurized air is proportional to the depth to which the air is submerged. The amount of energy (work) in the pressurized air is expressed by:

$$W = {P}_{0} {V}_{0} ( ( {log}_{n} \frac{{P}_{0}}{{P}_{a}} ) - 1 ) + {P}_{a} {V}_{0}$$

P₀=pressure in the tank
V₀=the volume
Pₐ=pressure of the atmosphere

As described above, the Gulf Stream retains its velocity all the way down to a depth of 800 meters. For example, the potential energy per 1 m³ air at 300 meters depth, using the above formula, would be:

### 3.98 KWh

The amount of energy per hour depends on the velocity of the cycle submersion/surfacing and hence the time in which a cycle can be completed. With an average velocity of 1 m/s:

$$T = \frac{\frac{( 2 h )}{U}}{3600}$$

h=depth, meters
U=velocity (m/s)
T=(300×2)/1)/3,600=0.1666667 hours.

This gives

$$Nbr = \frac{1}{0.166667} = 6 , 0$$

cycles of submerging/surfacing per hour, giving the following work per hour: 3.98×6.0=23.88 kwh per m³ air, which in turn gives 216 MWh/year/m³.

### Example

### Area

Prior art methods are based on blades/propellers rotating as a consequence of a liquid flow and/or liquid pressure (as a subsea windmill). This limits the size of the area that can be utilized due to mechanical loads, inter alia on shafts and propeller supports. This limits the opportunities for catching the energy in a cost effective manner.

### Advantages of the Invention

A very large hydrofoil area can be disposed in the flow of liquid without the serious problems of torque about shafts, loose elements etc. The liquid in which the hydrofoil is immersed is naturally supportive. Hence, by the present invention, the area can be substantially increased compared to a rotating solution.

### Example

### Moving Parts

Prior art methods commonly utilize a rotating element that in turn drives a generator or the like. Such mechanical solutions cause major wear on the moving parts.

### Advantages of the Invention

The hydrofoil has no rotating elements or corresponding shafts and few movable parts. It is not subject to equal mechanical challenges as in presently known technology. The simplicity also implies that the investments are reduced, and hence increases the possibility for producing renewable energy less expensive, which would give a gain in the environment balance.

### Example

### Yield and Energy Conversion

Known methods transmit power in the liquid flow via rotating equipment and generators. When electricity is provided via rotating motion and force, the energy must once more be converted to some form of energy carrier, e.g. a battery or hydrogen in order to move a car. This implies a substantial energy loss and reduced yield.

A typical windmill presently has an effect of 2 MW (nominal). The yield of a windmill is calculated by:

W=ω₀ω₁ω₂

At a particularly suitable location with much wind, an uptime of about 70% (ω₀) and a wind velocity of 60% (ω₁) of nominal value can be expected as an annual average.

In addition comes the yield on conversion to a given energy carrier. This will vary depending on the chosen energy carrier, but will under no circumstances exceed 60% (ω₂), which yields:

W=0.7*0.6*0.6=0.252.

### Advantage of the Invention

The energy is transferred to an energy carrier, air, in one step, and hence will produce a far better yield. Loss when generating pressurized air, occurs in the form of heat transmission. As approximately unlimited cooling capacity is available from the surrounding sea, the compression will be substantially isothermic, with minimal heat loss.

1. Method for converting kinetic energy in a flow of liquid, wherein a foil (1) is disposed in the flow of liquid such that the foil (1) can be moved cyclically in directions (12, 13) perpendicular to the flow of liquid between an uppermost level (h1) and a lowermost level (d1) depending on the lift of the foil (1), comprising:
confining a compressible fluid in a pressure tank (100) connected to the foil (1) at a first pressure when the foil (1) is at the uppermost level (h1);
controlling the lift of the foil (1) such that the foil (1) is subjected to a force in a downward direction;
allowing the compressible fluid to compress as long as the foil (1) is moving downwards;
confining the compressed fluid in the pressure tank (100) at a second pressure when the foil (1) is at the lowermost level (d1);
controlling the lift of the foil (1) such that the foil (1) is subjected to a force in an upward direction;
preventing the compressible fluid from expanding while the foil (1) is moving in an upward direction, and;
removing the potential energy of the compressed fluid from the pressure tank (100) when the foil (1) is at the uppermost level (h1).

2. Method according to claim 1, further comprising that the compressible fluid is air, and that the potential energy is removed as pressurized air for further transport and sale.

3. Method according to claim 1, further comprising removing the potential energy from the foil (1) by connecting the second pressure to the inlet of a turbine connected to an electric generator (24) at the surface.

4. Method according to claim 1, further comprising that the cyclic movement is used to drive a pulley (25) connected to a rotor in a stator in an electric generator at the surface.

5. Apparatus for converting kinetic energy in a flow of liquid, comprising:
a foil (1) disposed in the flow of liquid such that the foil (1) can be moved in directions (12, 13) perpendicular to the flow of liquid between an uppermost level (h1) and a lowermost level (d1);
a controlling means (14, 15, 23) for controlling the lift of the foil in the directions (12, 13) perpendicular to the direction of the flow of liquid;
characterized in that the foil (1) is attached to a pressure tank (100) comprising an inlet for compressible fluid;
at least one valve (120) adapted to prevent or allow a fluid flow through the inlet;
a piston (110) adapted to move inward in the pressure tank (110) as the ambient pressure increases; and
a means to lock the piston in an inner position (102).

6. Apparatus according to claim 5, further comprising that the compressible fluid is air, and that the apparatus further comprises means (120, 121) to convey pressurized air from the foil (1).

7. Apparatus according to claim 5, characterized in that the foil (1) is further connected by wire to a pulley (25) driving a rotor in a stator in an electric generator (24) at the surface.
